(19) United States
(12) Patent Application Publication
(10) Pub. No.: US 2002/0163792 A1
(43) Pub. Date: Nov. 7, 2002

(54) Illuminated tire valve cap

(76) Inventor: Vincent J. Formoso, Deltona, FL (US)

Correspondence Address: Richard C. Litman, LITMAN LAW OFFICES, LTD., P.O. Box 15035, Arlington, VA, 22215, US

(21) Appl. No.: 10/002,116

(22) Filed: Dec. 5, 2001

Related U.S. Application Data
(60) Provisional application No. 60/288,092, filed on May 3, 2001.

(51) Int. Cl. F21K 2/00

(52) U.S. Cl. 362/34; 362/500; 362/549; 362/191

(57) ABSTRACT

An illuminated tire valve cap includes one or more loops or sockets for removably receiving a corresponding number of small, chemiluminescent rod(s) therein. The chemiluminescent element(s) is/are separably replaceable from the valve cap, thereby allowing retention of the cap for further use when spent chemiluminescent elements have been removed. The chemiluminescent element retaining loop(s) may be provided across the top or along the side(s) of the valve cap, at any practicable orientation desired. The present illuminated valve cap “dresses up” the appearance of a vehicle wheel (automobile, truck, motorcycle, bicycle, etc.) without requiring relatively fragile, heavy electrically powered systems, which would unbalance the wheel and tire assembly and which would not provide the desired reliability. The present illuminated valve cap is also valuable in locating the cap at night or in poor lighting, for checking tire pressure and other tire maintenance tasks.

### CROSS-REFERENCE TO RELATED APPLICATION

This application claims the benefit of U.S. Provisional Patent Application Serial No. 60/288,092, filed May 3, 2001.

### BACKGROUND OF THE INVENTION

1. Field of the Invention

The present invention relates generally to illuminated decorative articles, and more specifically to one or more chemiluminescent inserts for incorporation with a specially configured tire valve cap. Several embodiments of the present invention are disclosed herein, which provide an eye catching appearance on motor vehicles as well as enhancing safety and facilitating location of the tire valve cap, both on the wheel and when removed from the wheel.

2. Description of Related Art

Various accessories for highlighting the appearance of automobiles and other motor vehicles, have been popular for many years. One subset of such decorative articles comprises illuminated articles of various types. Many people enjoy the installation of such illuminated articles on their vehicles, as they not only provide additional decoration, but also increase safety by providing additional illumination.

A number of various actively illuminated accessories for motor vehicles have been developed in the past, ranging from additional marker lights, illuminated license plate frames, underbody lighting, etc. In addition, innumerable reflective or passive lighting devices have also been developed for automobiles, motorcycles, and other vehicles. Nearly all of the actively illuminated devices are adapted for installation upon a relatively stationary portion of the vehicle (as opposed to the rotating wheels and tires), due to the relatively complex componentry required for electrically lighted articles. While various passive lighting devices have been developed for attachment to various areas of vehicle wheels, spokes, etc., these devices rely upon some ambient light for their reflectivity, and are completely ineffective when no source of light is available.

A need is thus apparent for a device for actively illuminating a tire valve cap, and a tire valve cap adapted for holding such an active illumination device. The present invention makes use of small conventional chemiluminescent devices, which may be removably inserted into one or more holders or sleeves formed integrally with the tire valve cap to hold the chemiluminescent device temporarily in place. The valve caps of the present invention facilitate removal of spent chemiluminescent devices and replacement with fresh devices, thereby allowing the cap to be reused indefinitely.

A discussion of the related art of which the present inventor is aware, and its differences and distinctions from the present invention, is provided below.

U.S. Pat. No. 2,382,832 issued on Aug. 14, 1945 to Charles W. Thornton, titled “Signal Device For Vehicles,” describes a passive reflector for installation upon a vehicle tire valve stem. The Thornton device incorporates the valve cap integrally therewith, necessitating the purchase of the entire valve cap and reflector assembly as a unitary component. In contrast, the present invention requires an initial purchase of the specially adapted valve cap or caps, with the lighting means being replaceable therein as desired or required. Moreover, the Thornton device requires a source of primary light for operation, whereas the present illuminated valve cap acts as a primary light source.

U.S. Pat. No. 2,756,412 issued on Jul. 24, 1956 to Frank A. Harrington, titled “Moistureproof Cap Assembly With Pilot Light Test Means,” describes an annunciator light assembly for installation in aircraft panels. The Harrington device includes a “press to test” feature, with an elastomeric sleeve surrounding the upper and outer lens element. Manual compression of the sleeve results in contact of the test terminals to illuminate the incandescent light therein. The Harrington device is not adaptable for use with a valve cap, as the internal end of the device which would extend into the valve stem, includes a series of electrical terminals extending therefrom. The Harrington device requires a source of electrical energy for operation, and Harrington does not disclose such a source other than to imply its conventional availability in an aircraft instrument panel. No means for lighting the Harrington device in a rotating object, is disclosed.

U.S. Pat. No. 3,938,078 issued on Feb. 10, 1976 to Raymond D. Davis et al., titled “Low Tire Pressure Indicating Device,” describes a device comprising a sealed liquid filled tube having a small battery, electric light source, and spring contacts at its distal end, and a seal which bears against the release stem of the conventional Schrader valve within the valve stem of a tire. The compressive force of the distal end spring is set at a predetermined level, with the pressure within the tire (and Schrader valve) normally being higher. If tire pressure drops below a certain predetermined level, the distal spring develops a greater pressure than that developed by the Schrader valve and tire air pressure, whereupon the distal spring extends to close the contacts and illuminate the light. The Davis et al. device will be seen to be relatively complex and heavy, resulting in tire imbalance unless compensating weight is applied elsewhere. Moreover, the intermittent nature of the Davis et al. device, operating only in conditions of low tire pressure, precludes its use as a continuously illuminated decorative article or as a continuous warning to others.

U.S. Pat. No. 4,194,810 issued on Mar. 25, 1980 to Dennis E. Eller, titled “Truck Tire Safety Reflector,” describes a passive reflector which clips to the rim of a wheel. The device is thus not related to the tire valve mechanism in any way, other than its use with a vehicle wheel. Moreover, the Eller device is passively reflective, and does not incorporate any active lighting means, as provided by the present invention.

U.S. Pat. No. 4,289,376 issued on Sep. 15, 1981 to Dragan Vukadinovic, titled “Light Reflectors,” describes a passive reflector comprising an elongate strip with a series of holes. One of the holes of the strip is placed around the threaded end of the valve stem, and the valve cap is secured thereover to secure the device to the wheel. The opposite end of the strip has a reflector attached thereto. The passive reflectivity of the Vukadinovic device is more closely related to the reflective valve cap disclosed in the Thornton '832 U.S. Patent, described further above, than to the present chemiluminescent lighted valve cap.

U.S. Pat. No. 4,847,735 issued on Jul. 11, 1989 to Masaki Kawasaki, titled “Fitting Structure Of Safety Lamp To Wheel,” describes both electrically and chemically activated lighting means for vehicle valve caps. FIGS. 4 through 6 disclose an integrally formed chemiluminescent device which also serves as the tire valve cap; it cannot be installed with an existing cap, or with another cap adapted to hold the device. It is well known that chemiluminescent reactions are relatively short lived. Thus, the Kawasaki device would require replacement of the entire cap assembly so long as it was desired to retain the lighted cap function, with replacement being required perhaps every several hours. The present invention greatly reduces the costs involved by providing a permanent valve cap adapted to hold a replaceable chemiluminescent stick, thus requiring replacement of only the relatively inexpensive chemiluminescent stick as desired. Moreover, the present invention includes various attachment geometries for the chemiluminescent device, which are not anticipated by Kawasaki. Although Kawasaki discloses a lateral electrically illuminated device, he provides only a single, concentric chemiluminescent configuration and thus clearly does not anticipate any of the other chemiluminescent configurations disclosed herein.

U.S. Pat. No. 4,928,212 issued on May 22, 1990 to Butch Benavides, titled “Phosphorescent Vehicle Part Identification System,” describes various plastic components having phosphorescent compounds therein or therewith. A tire valve cap is noted as one of the articles which may be formed according to the Benavides disclosure. However, phosphorescence is a passive illumination principle, requiring an external source of light for operation. The principle is not at all like the active illumination provided by the chemical reaction of the chemiluminescent devices used in the present invention. In any event, the Benavides valve cap is a single, unitary device incorporating the phosphorescent means integrally therewith, and cannot be separated therefrom.

U.S. Pat. No. 5,161,056 issued on Nov. 3, 1992 to Matthew J. Sitter, titled “Reflector-Ornament Holder For Vehicle Wheels,” describes a valve cap incorporating reflective means therewith. As the Sitter device is passively illuminated and relies upon reflected light, it more closely resembles the device of the Thornton '832 U.S. Patent, discussed further above, than the present valve cap with its chemiluminescent illumination means.

U.S. Pat. No. 5,876,108 issued on Mar. 2, 1999 to Tseng Lu Chien, titled “Illuminated Rotating Object,” describes a relatively large, circular device using active lighting principles such as electroluminescence or photoluminescence. The Chien device requires a considerably larger volume than the present invention, and is thus more suited to use with wheel covers, hubcaps and the like, than the necessarily small size of a valve cap. The weight of the Chien device requires that it be centered on the wheel; it is not adaptable to off-center placement, such as the present illuminated tire valve cap. Chien does not disclose any means of incorporating his illumination means with a relatively small tire valve cap, nor does he describe any chemiluminescent lighting means, as provided by the present invention.

U.S. Pat. No. 6,070,997 issued on Jun. 6, 2000 to Mike A. Duke et al., titled “Waterproof Valve Stem Safety Light For Vehicles,” describes an electrically lighted assembly housed in a valve cap for attachment to the valve stem of a tire. The Duke et al. device is relatively complex, not only having a light source and batteries, but including switch means controlled by tightening or loosening the threaded attachment of the device. Duke et al. does not disclose any chemiluminescent lighting means, as used in the present illuminated tire valve cap invention, and moreover all of his structure (excepting the light itself) is internal, whereas the internal portion of the present valve cap is devoid of illumination means.

U.S. Pat. No. 6,176,603 issued on Jan. 23, 2001 to Lester Spicer, titled “Wheel Lighting System,” describes a system using neon or other electroluminescent lighting (but not chemiluminescence) to illuminate the back or inner side of a wheel on a vehicle. The Spicer lighting system is stationary relative to the rotation of the vehicle wheel (s), being mounted upon non-rotary components of the vehicle wheel hub assembly or other structure. The Spicer lighting system does not rotate nor does it attach to or communicate with any of the rotating parts of the vehicle (tires, valve caps, etc.), whereas the present lighting device uses chemiluminescence and rotates with the rotation of the tire valve cap(s) on the vehicle tire(s).

U.S. Pat. No. 6,186,635 issued on Feb. 13, 2001 to Gary Peterson et al., titled “Luminescent Safety Devices,” describes a phosphorescent and/or fluorescent device for attachment to a bicycle spoke for providing additional illumination of the bicycle in low light conditions. Peterson et al. specifically describe the mixture of phosphorescent and fluorescent materials used, as well as an electrically powered light fixed on a relatively stationary part of the bicycle for providing light energy for the phosphorescent and/or fluorescent materials of the device, to lengthen the period of illumination provided by the device. However, Peterson et al. make no provision for chemiluminescence, nor for replacing a spent luminescent device with a fresh device, as provided by the present chemiluminescent device and tire valve cap apparatus.

British Patent Publication No. 774,386 published on May 8, 1957 to Bluemel Bros. Limited, titled “Improvements In Or Relating To Portable Battery And Cycle Electric Lamps,” describes a conventional battery powered electric light, wherein the battery and incandescent bulb are contained in a single housing. The housing clamps conventionally to the cycle structure. The Bluemel Bros. device is not adaptable to attachment to a tire valve cap due to its size, weight, and inability to handle the centrifugal forces developed in such a rotating installation.

British Patent Publication No. 1,441,201 published on Jun. 30, 1976 to Beatrice Foods Co., titled “Spoke-Mountable Visual Display Device For Vehicle Wheels,” describes various embodiments of plastic reflectors for attachment to the spokes of a bicycle. The embodiments differ in their attachment means, with the sole visual means being described as a reflector. The Beatrice Foods device is thus more closely related to the device of the Peterson '635 U.S. Patent discussed further above, than to the present invention.

European Patent Publication No. 318,147 published on May 31, 1989 to Thomas B. Leon, titled “Wheel Mounted Safety Light,” describes a disc-shaped housing having a small battery contained therein and an LED type light extending from one surface of the disc. The opposite disc surface has a threaded socket formed therein, for attaching the device to a valve stem or the like. Leon does not disclose any chemiluminescent lighting means, nor does he provide a replaceable lighting element, as provided by the present invention.

Finally, Japanese Patent Publication No. 8-326,956 published on Dec. 10, 1996 to Fuji Univance:KK, titled “Tire Valve Cap,” describes (according to the English abstract and drawings) a valve cap having a built-in pneumatic pressure gauge therein. The cap includes a mechanism for equalizing pressure within the cap with that in the tire by pressing the cap, and a pressure gauge which may be read through a transparent outer cover. The transparency of the outer cover enables advertising or the like to be included within the device, and read or observed through the transparency of the cover. However, no lighting means whatsoever is apparent in the '956 Japanese Patent Publication. The pressure indication means provided by the device of the '956 Japanese Patent Publication appears to be more closely related to the device of the '078 U.S. Patent, discussed further above, than to the present illuminated tire valve cap invention.

None of the above inventions and patents, either singly or in combination, is seen to describe the instant invention as claimed.

### SUMMARY OF THE INVENTION

The present invention is an illuminated tire valve cap, wherein the cap includes retaining means for securing one or morel small, conventional chemiluminescent rods externally thereto. The rod(s) is/are exposed when held in the cap, enabling persons to see the glowing rod(s) during chemical activation of the chemiluminescent material therein. Various embodiments of the present valve cap are disclosed herein.

The present illuminated valve cap provides for replacement of the chemiluminescent element(s) therein, thus allowing the cap to be saved for future use. The present valve cap may be used for its conventional function, i.e., sealing the valve stem of a pneumatic tire and wheel assembly, without a chemiluminescent element(s) installed therewith. The present illuminated valve cap provides an economical, yet very attractive means, of “dressing up” a vehicle (automobile, motorcycle, bicycle, etc.) without resorting to relatively complex electrical or electronic components, which are not suitable for use in rapidly rotating environments such as vehicle wheel rims. The present valve cap also provides a further benefit, in that an illuminated chemiluminescent element(s) held therein, assists a person in locating the valve cap at night or in low light conditions for replenishing air in the tire, checking tire pressure, or other work where it is necessary to remove and replace the valve cap.

Accordingly, it is a principal object of the invention to provide an illuminated tire valve cap for tire and wheel assemblies of automobiles, motorcycles, bicycles, and other powered and non powered vehicles.

It is another object of the invention to provide such an illuminated tire valve cap in which the illumination means comprises at least one chemiluminescent element.

It is a further object of the invention to provide such an illuminated tire valve cap in which the chemiluminescent element(s) is/are removably replaceable, thus allowing reuse of the valve cap.

Still another object of the invention is to provide various embodiments of means for removably retaining the chemiluminescent element(s) on the tire valve cap, with at least the majority of the chemiluminescent element(s) being visible at all times when the valve cap is installed on the valve stem.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of an automobile and wheel and tire assembly incorporating an illuminated tire valve cap according to the present invention.

FIG. 2 is a detailed, exploded perspective view of a first embodiment of a tire valve cap including means for removably retaining a single chemiluminescent element therewith.

FIG. 3 is a detailed, exploded perspective view of another embodiment of a tire valve cap including alternative chemiluminescent element retention means therewith.

FIG. 4 is a detailed perspective view of yet another embodiment of the present illuminated tire valve cap, showing alternative chemiluminescent element retention means.

FIG. 5 is a detailed perspective view similar to the view of FIG. 4, but showing a further embodiment of the chemiluminescent element retention means.

FIG. 6 is a detailed perspective view of yet another embodiment of the present illuminated tire valve cap, showing another chemiluminescent element retention means thereon.

FIG. 7 is a detailed perspective view of still another embodiment of the present illuminated tire valve cap, showing still another chemiluminescent element retention means.

FIG. 8 is a detailed perspective view similar to the view of FIG. 6, but showing two symmetrically disposed chemiluminescent element retaining means.

FIG. 9 is a detailed perspective view similar to the view of FIG. 7, but showing two symmetrically disposed chemiluminescent element retaining means.

Similar reference characters denote corresponding features consistently throughout the attached drawings.

### DETAILED DESCRIPTION OF THE PREFERRED EMBODIMENTS

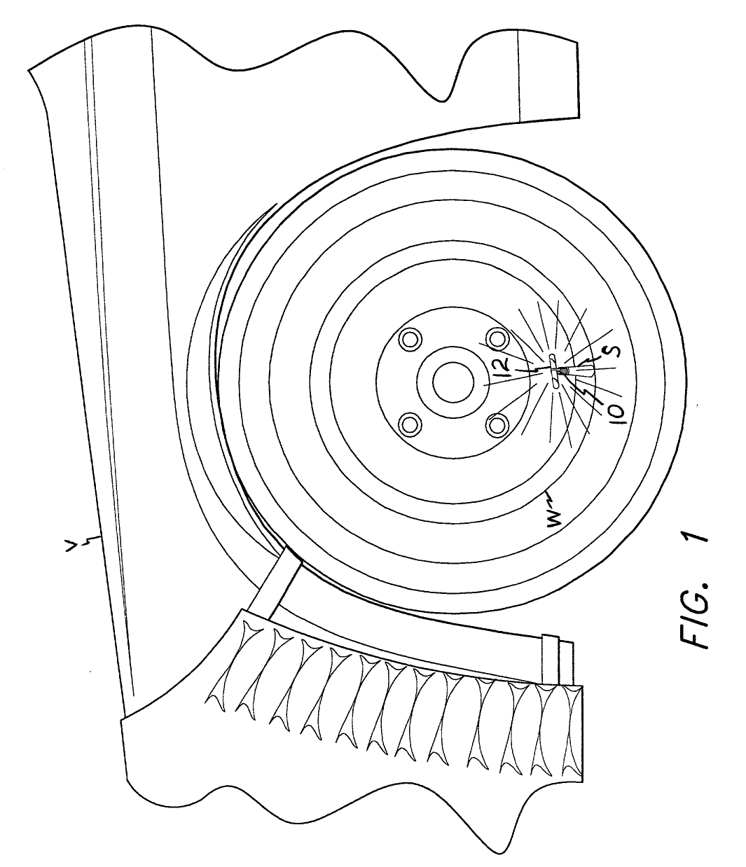

The present invention comprises various embodiments of an illuminated tire valve cap, with the cap including means for removably holding one or more small, lightweight chemiluminescent elements therein. FIG. 1 of the drawings provides an environmental view of a first embodiment of the present illuminated valve cap 10, illustrating the cap 10 and a small, lightweight chemiluminescent rod 12 removably installed therewith. The valve cap 10 is in turn secured to the conventional valve stem S extending from the wheel W of a vehicle V (car, light truck, etc.), and serves to “dress up” the vehicle V, particularly the rotating wheel W thereof, at night or in areas of low illumination. The present illuminated valve cap allows the chemiluminescent element(s) to be replaced as desired when the element(s) is/are spent, without requiring replacement of the cap also.

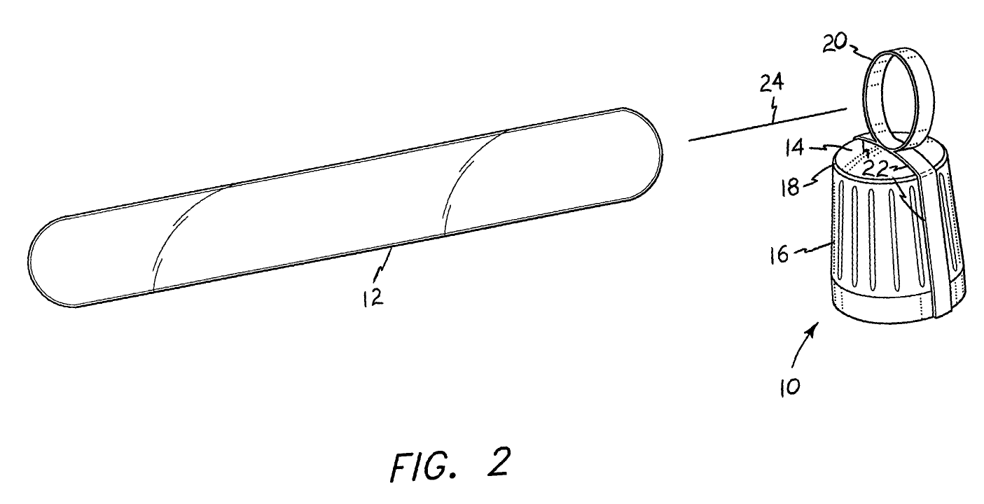

FIG. 2 provides a detailed view of the valve cap 10 embodiment shown generally in FIG. 1. The valve cap 10 of FIG. 2 has a top surface 14 and generally cylindrical side 16, defining the general shape of the cap 10. While the top 14 may be slightly convex in shape, its edge defines a top plane 18, reference to which may be made regarding the orientation of the holding means for the chemiluminescent element(s) in the various embodiments of the present invention. The generally cylindrical side 16 may be tapered from top to bottom of the cap 10, therefore more precisely forming a conical section. However, the taper is relatively slight and the overall shape will be seen to be generally cylindrical, which term encompasses such slight conical taper as well as purely cylindrical shapes for the purposes of the present disclosure.

The valve cap 10 includes a chemiluminescent element retainer loop 20 disposed atop the top 14 of the valve cap 10. Opposite valve cap attachment straps 22 extend across the top 14 and down the side 16 of the cap 10, to position the loop 20 in place. The attachment straps 22 are attached conventionally to the side 16 of the valve cap 10, e.g., by adhesive bonding with a suitable agent or cement. The loop 20 of the cap 10 of FIGS. 1 and 2 has a chemiluminescent element retaining axis 24 disposed generally parallel to the top 14 and top plane 18 of the cap 10. This generally optimizes the display of the chemiluminescent element, depending upon the orientation of the loop 20 once the cap 10 has been threaded on to the valve stem S. However, other retainer loop orientations may be provided, as illustrated in other drawing Figs.

Preferably, the chemiluminescent element retainer is formed integrally with the cap at the time of cap manufacture, but the retainer may be added after manufacture as in the embodiment of FIGS. 1 and 2, if so desired. The retainer loop 20 is preferably formed of a somewhat resilient material with an inner diameter slightly less than the diameter of the chemiluminescent rod 12, in order to provide a firm grip for retaining the rod 12 therein. Natural or synthetic rubber or other elastomer material having a relatively low durometer may be used as desired for such “add-on” chemiluminescent retainer loops, where the retainer means is not formed integrally with the valve cap at the time of manufacture.

The chemiluminescent element 12 is a conventional chemiluminescent device, formed as a small, lightweight, elongate rod, having a flexible plastic outer shell and a length of about one and one half inches and a diameter of about one eighth of an inch. Other dimensions may be used as desired, so long as they fit closely within the retaining element of the present illuminated tire valve cap invention. The relatively small size of the chemiluminescent rod element 12 (and those illustrated in other drawing Figs. and discussed further below) provides a very light weight, only on the order of a small fraction of an ounce. This greatly reduces the inertial and centrifugal forces upon such a device during the rotation of the wheel, allowing the resilient retaining loop 20 to grip the chemiluminescent element 12 securely without concern for the chemiluminescent element 12 working loose, yet permitting the user to remove and replace elements as required.

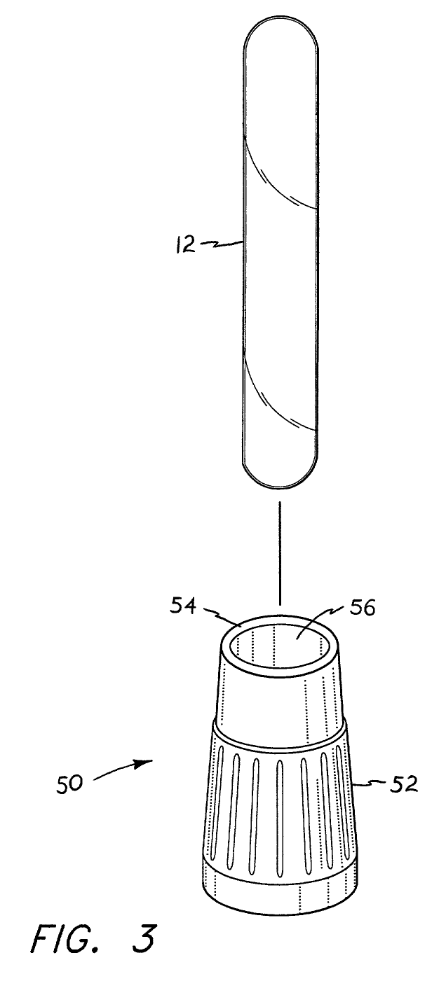

FIG. 3 of the drawings illustrates a second embodiment of the present illuminated tire valve, designated by the reference numeral 50. The tire valve 50 embodiment includes a generally cylindrical (or perhaps slightly conical) side surface 52 with an upper edge or rim 54. However, rather than having a separate chemiluminescent element retaining loop, as in the embodiment of FIGS. 1 and 2, the illuminated tire valve cap 50 of FIG. 3 includes a chemiluminescent element retaining socket 56 formed integrally in the top thereof. The socket or receptacle 56 has an internal diameter configured to fit tightly about the outer diameter of the chemiluminescent rod 12, thereby holding the rod 12 securely to the valve cap 50 until removal is desired by the user. As the chemiluminescent rod receptacle 56 is coaxial with the valve cap 50, the centrifugal force due to the rotation of the wheel to which the cap 50 is secured, tends to hold the chemiluminescent element 12 securely in place within the valve cap 50 during wheel rotation.

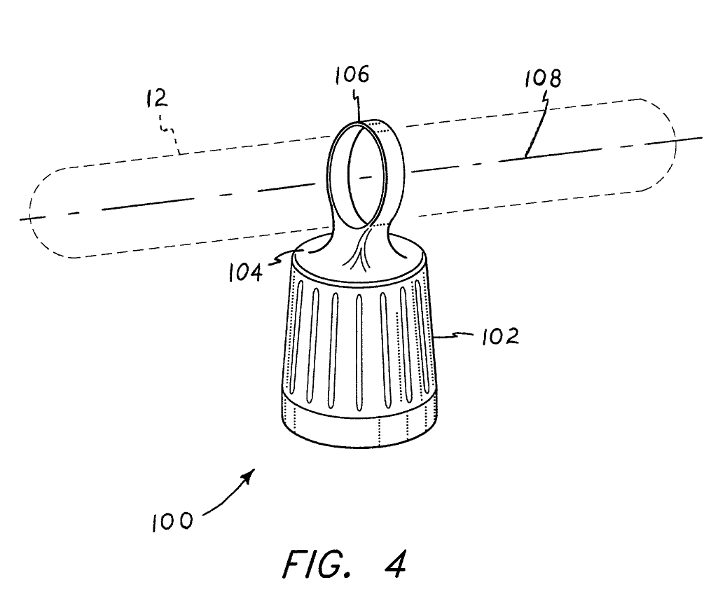

FIG. 4 illustrates yet another embodiment of the present invention, designated as illuminated tire valve cap 100. The valve cap 100 includes a generally cylindrical or slightly conical side 102 and a top 104, as in the other valve caps described above. However, the valve cap 100 provides an alternative means of securing a chemiluminescent rod 12 (shown in broken lines in FIG. 3) therein, comprising a chemiluminescent rod retaining loop 106 formed integrally with the remainder of the valve cap 100 structure at the time of manufacture, rather than being added as a separate component. The loop 106 extends from the top 104 of the valve cap 100 and has a chemiluminescent element retaining axis 108 disposed generally parallel to the plane defined by the top 104 of the tire valve cap 100, as in the embodiment of FIGS. 1 and 2. This lateral or transverse axial disposition of the loop axis 108, and any chemiluminescent element 12 placed therein, provides optimum display of the chemiluminescent rod 12 while generally balancing the centrifugal loads thereon so that there are no net forces acting to dislodge the chemiluminescent element 12 from the tire valve loop 106 during wheel rotation.

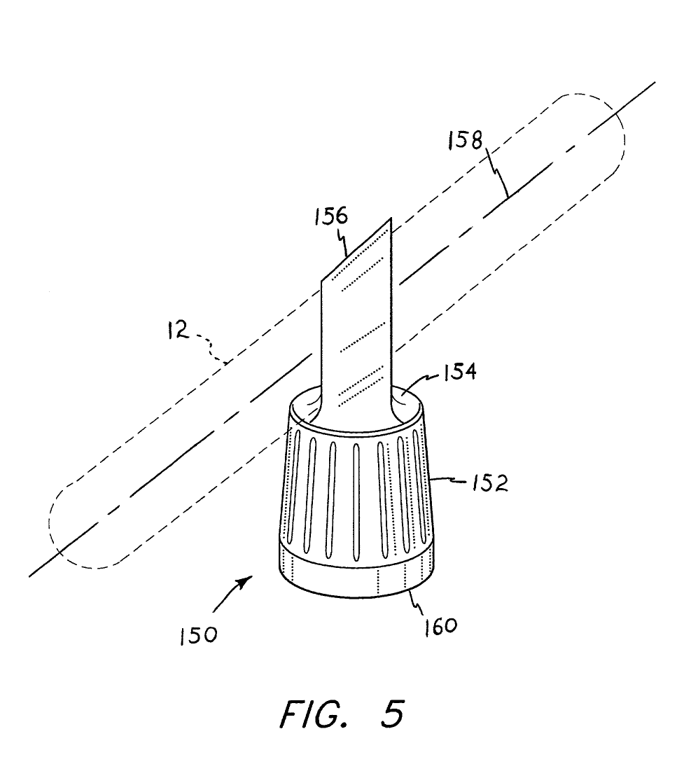

FIG. 5 provides still another embodiment of the present illuminated tire valve cap invention, designated as valve cap 150. The cap 150 includes a generally cylindrical side surface 152 and a top 154, in a manner similar to that of the caps 10, 50, and 100 discussed further above. The cap 150 includes a chemiluminescent element retaining loop 156 formed integrally with the cap 150 and extending from the top 154 thereof, in the general manner of the valve cap 100 of FIG. 4. However, the chemiluminescent element retaining axis 158 of the retaining loop 156 is disposed at a sloped angle to the top 154 of the valve cap 150. This may be disadvantageous in that centrifugal force may tend to cause the chemiluminescent rod element 12 (shown in broken lines in FIG. 5) to become dislodged toward the outer edge or base 160 of the valve cap 150 during wheel rotation. However, it also assures nearly complete display of the entire chemiluminescent rod 12, regardless of the axial orientation of the valve cap 150 due to its final seated position after being threaded onto the valve stem.

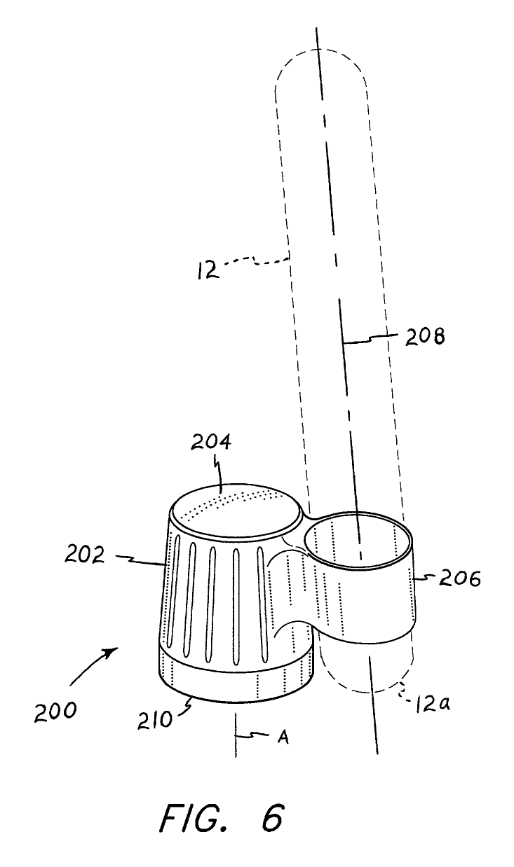

FIG. 6 illustrates a perspective view of a further embodiment of the present invention, designated as illuminated tire valve cap 200. As in the other tire valve caps of the present invention, the valve cap 200 includes a generally cylindrical side 202 and a top 204. However, rather than forming the chemiluminescent element retaining loop to extend from the top of the valve cap, the retaining loop 206 extends from the side 202 of the cap 200 of FIG. 6.

It will be seen that the chemiluminescent element retaining axis may be oriented in any practicable direction as desired. In the case of the valve cap 200 of FIG. 6, the retaining axis 208 is oriented generally normal to the top surface 204 of the cap 200. This results in the chemiluminescent rod element 12 (shown in broken lines in FIG. 6) being oriented generally parallel to the valve stem axis A of the valve cap 200, and extending upwardly therebeyond. This results in the display of the greater majority of the chemiluminescent element 12 from the valve cap 200. It will be seen that this orientation produces unbalanced forces which tend to urge the chemiluminescent element 12 outwardly from the retaining loop 206, toward the base 210 of the valve cap 200, when the wheel to which the valve cap 200 is secured, is rotating. However, the outer or lower end 12a of the chemiluminescent element 12 contacts the underlying wheel rim (not shown in FIG. 6) if it moves outwardly or downwardly through the retaining loop 206 to any extent, with the wheel structure preventing further movement of the chemiluminescent element 12.

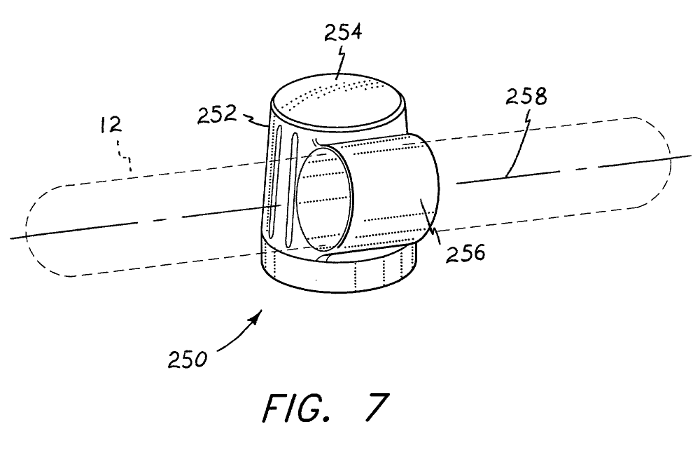

An additional embodiment is illustrated in FIG. 7 of the drawings, designated as illuminated tire valve 250. The tire valve 250 of FIG. 7 also has a side surface 252 and a top 254, generally in the manner of the other tire valves of the present invention discussed further above and illustrated in FIGS. 1 through 6 of the drawings. A chemiluminescent element retaining loop 256 extends from the side 252 of the valve cap 250, generally in the manner of the valve cap 200 and retaining loop 206 of FIG. 6. However, the axis 258 of the retaining loop 256 of the valve cap 250 of FIG. 7 is oriented generally perpendicular to the retaining loop 206 orientation of the cap 200 of FIG. 6, i.e., generally parallel to the top surface 254 of the cap 250. This orientation extends the chemiluminescent element 12 (shown in broken lines) substantially equally to both sides of the retaining loop 256, thus generally equalizing any forces on the chemiluminescent element 12 due to wheel rotation. The tight but resilient hold of the resilient retaining loop 256, thus holds the chemiluminescent element 12 securely in place until the user of the device wishes to remove it.

It will be seen that other orientations of such a side disposed chemiluminescent element retaining loop may be provided as desired, e.g., with the axis at some angle between the two shown in FIGS. 6 and 7, as desired. Other arrangements, e.g., with the retaining loop extending from the edge or juncture of the top and side of the valve cap, may also be formed as desired, with the axis of such retaining loops oriented as desired.

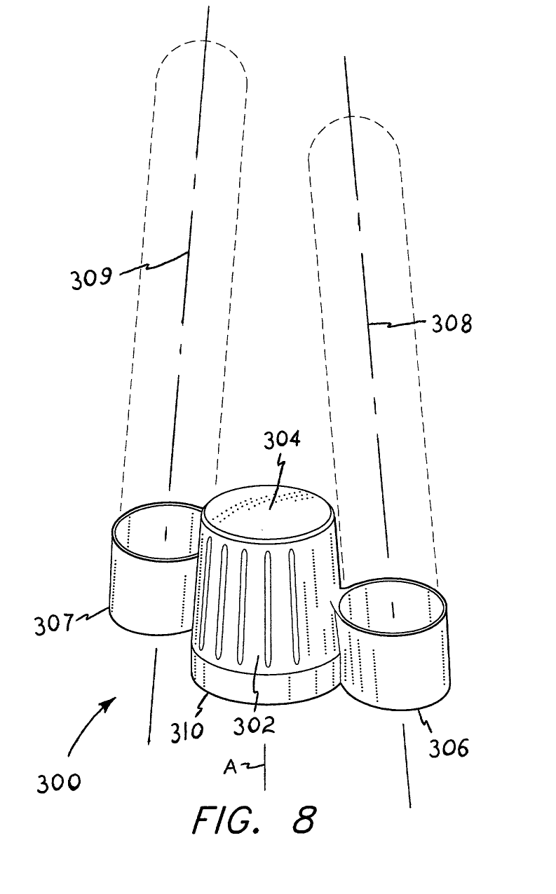

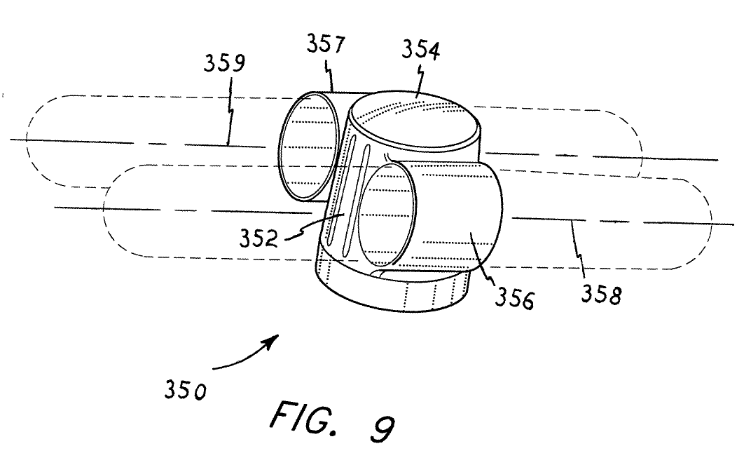

FIGS. 1 through 7 illustrate a series of embodiments each having only a single chemiluminescent element retaining loop therewith. However, it will be seen that the present invention may be configured to hold more than a single chemiluminescent element, if so desired. FIGS. 8 and 9 illustrate a pair of such exemplary embodiments.

The illuminated valve cap 300 of FIG. 8 will be seen to be an essentially laterally symmetrical variation of the valve cap 200 of FIG. 6, having a generally cylindrical side 302 and a top 304. However, rather than forming a single chemiluminescent element retaining loop to extend from the top of the valve cap, two symmetrically distributed retaining loops 306 and 307 extend oppositely from the side 302 of the cap 300 of FIG. 8.

The two retaining axes 308 and 309 of the respective retaining loops 306 and 307 are oriented generally normal to the top surface 304 of the cap 300, similarly to the orientation of the single retaining loop 206 of the valve cap 200 of FIG. 6. This results in the two chemiluminescent rod elements 12 (shown in broken lines in FIG. 8) being oriented generally parallel to the valve stem axis A of the valve cap 300, and extending upwardly therebeyond. (The taper of the valve cap side 302 may result in some convergence of the two axes 308 and 309, but for all practical purposes, they are generally parallel to one another.) This results in the display of the greater majority of the chemiluminescent element 12 from the valve cap 200. This is even more so in the case of the multiple element cap 300 of FIG. 8 when compared to the retaining element configuration of the cap 200 of FIG. 6, in that the two retaining elements 306 and 307 of the cap 300 are lower on the side of the cap 300, with their base ends disposed generally coplanar with the base 310 of the cap 300. This serves to expose a greater amount of the two chemiluminescent elements 12 beyond their respective retaining elements 306 and 307, to provide better visibility for the chemiluminescent elements. However, it will be seen that the multiple retaining loops 306 and 307 of the cap 300 of FIG. 8 may be positioned higher on the side 302 of the cap 300, if so desired, and conversely, the single loop 206 of the cap 200 may be positioned lower toward the base 210 of the cap 200, if so desired.

While only two chemiluminescent retaining loop elements 306 and 307 are provided with the valve cap 300 of FIG. 8, it should be noted that additional such retaining loop elements may be provided with such a cap, as desired. A series of three or more such retaining loops may be disposed symmetrically, or asymmetrically, about the side 302 of the valve cap 300, as desired. Additional chemiluminescent retaining loops may be provided on any of the embodiments of the present invention, where practicable.

FIG. 9 illustrates another multiple element embodiment, with the two retaining elements oriented generally parallel to the plane of the top surface of the cap, similarly to the single element embodiment of FIG. 7. The tire valve 350 of FIG. 9 also has a side surface 352 and a top 354, generally in the manner of the other tire valves of the present invention discussed further above and illustrated in FIGS. 1 through 8 of the drawings. However, a pair of symmetrically disposed chemiluminescent element retaining loops 356 and 357 extend from the side 352 of the valve cap 350, generally in the manner of the valve cap 200 and retaining loop 206 of FIG. 6.

However, the axes 358 and 359 of the respective retaining loops 356 and 357 of the valve cap 350 of FIG. 9 are oriented generally perpendicular to the retaining loop 306 and 307 orientation of the cap 300 of FIG. 8, i.e., generally parallel to the top surface 354 of the cap 350. This orientation extends the two chemiluminescent elements 12 (shown in broken lines) substantially equally to both sides of their respective retaining loops 356 and 357, thus generally equalizing any forces on the chemiluminescent element 12 due to wheel rotation, as in the case of the single chemiluminescent element and retaining loop 256 of the valve cap 250 of FIG. 7. The tight but resilient hold of the resilient retaining loops 356 and 357, thus holds the respective chemiluminescent elements 12 securely in place until the user of the device wishes to remove them.

In conclusion, the present illuminated tire valve cap in its various embodiments provides an extremely economical means of “dressing up” the appearance of virtually any vehicle (automobile, motorcycle, bicycle, etc.) which incorporates pneumatic tires with tire valve stems and valve caps. As such chemiluminescent elements come in virtually any desirable color, the user of the present invention may interchangeably install any color desired to complement or contrast with other colors, and/or to indicate a potential hazard (red, amber, etc.), or for other purposes. The present invention allows the user to interchange the different colors in only seconds, without need to remove and replace the tire valve cap or to discard the cap.

The present illuminated valve cap invention provides illumination of the valve cap, without requiring costly, fragile, and massive electrical components (lights, batteries, etc.). As the chemiluminescent devices used with the present valve cap are extremely light weight, weighing only a small fraction of an ounce, they do not affect wheel balance to any noticeable degree, nor do they tend to work loose from the retaining loop of the valve cap. Such small chemiluminescent rod elements provide light for up to several hours once activated, and can thus provide lighted display for an entire evening of driving, or at a car show or other event as desired.

Replacement is extremely easy, requiring only a few seconds at each valve cap when replacement is desired. Such chemiluminescent technology is well developed, thus making the small chemiluminescent elements quite inexpensive. A set of four may be installed on the valve caps of a vehicle for a total cost of a dollar or less. Even greater economy is provided by the present invention in that the valve caps are reusable, and require replacement of only the chemiluminescent elements themselves as desired.

While small, elongate chemiluminescent rods have been described herein as the chemiluminescent elements used with the present illuminated valve cap invention, it will be seen that other chemiluminescent element shapes may be used, with the valve cap configured to provide a secure hold for such differently shaped chemiluminescent elements. The present illuminated valve cap invention will thus find great favor with persons desiring to enhance the appearance of their vehicles, regardless of the type of vehicle, and can provide additional safety for the vehicle operator as well, particularly in the case of smaller vehicles having relatively little lighting, e.g., bicycles.

The present illuminated valve caps are also of great assistance where minor tire maintenance is required at night or in poorly illuminated conditions, e.g., checking tire air pressure, etc. As no reflective means is used in the present invention, no source of ambient lighting is required, as is the case with conventional spoke attached reflectors for bicycles and other similar reflective devices. The present invention thus provides significant improvements in function and economy, as well as enhancing vehicle appearance and operator safety, for virtually all vehicles and operators.

It is to be understood that the present invention is not limited to the embodiments described above, but encompasses any and all embodiments within the scope of the following claims.

I claim:

1. An illuminated tire valve cap, comprising:
a tire valve cap having a top and generally cylindrical side;
at least one chemiluminescent element; and
means for removably and replaceably securing said at least one chemiluminescent element externally to said tire valve cap.

2. The illuminated tire valve cap according to claim 1, wherein said at least one chemiluminescent element comprises at least one small, light weight, elongate rod.

3. The illuminated tire valve cap according to claim 1, wherein said means for removably and replaceably securing said at least one chemiluminescent element externally to said tire valve cap comprises at least one loop element permanently affixed externally to said tire valve cap.

4. The illuminated tire valve cap according to claim 1, wherein said means for removably and replaceably securing said at least one chemiluminescent element externally to said tire valve cap comprises a socket formed integrally in said top of said tire valve cap.

5. The illuminated tire valve cap according to claim 1, wherein said means for removably and replaceably securing said at least one chemiluminescent element externally to said tire valve cap comprises at least one loop element formed integrally with said tire valve cap.

6. The illuminated tire valve cap according to claim 5, wherein said at least one loop element comprises a single loop element extending from said top of said tire valve cap; and
said single loop element has a chemiluminescent element retaining axis generally parallel to said top of said tire valve cap.

7. The illuminated tire valve cap according to claim 5, wherein said loop element comprises a single loop element extending from said top of said tire valve cap; and
said single loop element has a chemiluminescent element retaining axis forming a sloped angle relative to said top of said tire valve cap.

8. The illuminated tire valve cap according to claim 5, wherein said at least one loop element extends from said side of said tire valve cap; and
said at least one loop element has a chemiluminescent element retaining axis generally normal to said top of said tire valve cap.

9. The illuminated tire valve cap according to claim 5, wherein said at least one loop element extends from said side of said tire valve cap; and
said at least one loop element has a chemiluminescent element retaining axis generally parallel to said top of said tire valve cap.

10. An illuminated tire valve cap, comprising:
a tire valve cap;
at least one small, lightweight, elongate chemiluminescent rod; and
at least one chemiluminescent rod retaining element permanently affixed externally to said tire valve cap.

11. The illuminated tire valve cap according to claim 10, wherein said at least one chemiluminescent rod retaining element comprises a single loop element disposed externally to said tire valve cap.

12. The illuminated tire valve cap according to claim 10, wherein said at least one chemiluminescent rod retaining element comprises a plurality of loop elements disposed externally to said tire valve cap.

13. An illuminated tire valve cap, comprising:
a tire valve cap;
at least one small lightweight, elongate chemiluminescent rod; and
at least one chemiluminescent rod retaining element formed integrally with and disposed externally to said tire valve cap.

14. The illuminated tire valve cap according to claim 13, wherein said at least one chemiluminescent rod retaining element comprises a socket formed integrally in said top of said tire valve cap.

15. The illuminated tire valve cap according to claim 13, wherein said at least one chemiluminescent rod retaining element comprises at least one loop element formed integrally with said tire valve cap.

16. The illuminated tire valve cap according to claim 15, wherein said at least one loop element extends from said top of said tire valve cap; and
said at least one loop element having a chemiluminescent element retaining axis generally parallel to said top of said tire valve cap.

17. The illuminated tire valve cap according to claim 15, wherein said at least one loop element extends from said top of said tire valve cap; and
said at least one loop element has a chemiluminescent rod retaining axis forming a sloped angle relative to said top of said tire valve cap.

18. The illuminated tire valve cap according to claim 15, wherein said at least one loop element extends from said side of said tire valve cap; and
said at least one loop element has a chemiluminescent rod retaining axis generally normal to said top of said tire valve cap.

19. The illuminated tire valve cap according to claim 15, wherein said at least one loop element extends from said side of said tire valve cap; and
said at least one loop element has a chemiluminescent rod retaining axis generally parallel to said top of said tire valve cap.

20. The illuminated tire valve cap according to claim 15, wherein said at least one loop element comprises a plurality of symmetrically distributed loop elements disposed externally to said valve cap.
